(19) United States
(12) Patent Application Publication
(10) Pub. No.: US 2025/0199942 A1
(43) Pub. Date: Jun. 19, 2025

(54) METHOD AND APPARATUS FOR VERIFYING UPDATED SOFTWARE

(71) Applicants: Hyundai Motor Company, Seoul (KR); Kia Corporation, Seoul (KR)

(72) Inventor: Seong Un Kim, Anyang (KR)

(21) Appl. No.: 18/669,940

(22) Filed: May 21, 2024

(30) Foreign Application Priority Data
Dec. 18, 2023 (KR) 10-2023-0184665

(51) Int. Cl. G06F 11/36; G06F 8/65

(52) U.S. Cl. CPC G06F 11/368; G06F 8/65

(57) ABSTRACT

A method and apparatus for verifying updated software may be associated with an infotainment platform of a vehicle. The software verification method includes receiving data for software verification from an external server or external device, generating a flow map based on the received data, updating the flow map based on updated change specifications of software, reconfiguring the updated flow map based on estimated usage frequency of a display identifier (ID) added in the updated change specifications of the software, and verifying the changed specifications of the software by performing tests on the reconfigured flow map, where the display ID is a unique identifier assigned to each screen displayable during a software execution process.

### CROSS REFERENCE TO RELATED APPLICATION

The present application claims under 35 U.S.C. § 119 (a) the benefit of Korean Patent Application No. 10-2023-0184665, filed Dec. 18, 2023, the entire contents of which are incorporated by reference herein.

### BACKGROUND

### (a) Technical Field

The present disclosure relates to a method and apparatus for verifying updated software, for example, infotainment platform software for a vehicle, which may be updated based on big data and changed software specifications.

### (b) Description of the Related Art

The growing frequency and expansion of wireless and wired updates for in-vehicle infotainment systems underscore the increasing significance of verifying software updates. Regardless of developing new platforms or projects, there is a pressing need for more efficient and focused software integration verification within relatively short time frames during the validation and deployment of software. Traditional software verification methods have primarily centered around evaluators based on changing specifications, with user big data mainly serving overall statistical purposes. However, the demand for a more user-centric and intensive software verification approach has intensified due to unexpected issues arising from customer usage scenarios after software deployment.

In traditional software verification technologies, user data has been underutilized, serving only simple statistical purposes or not actively contributing to the verification process. For periodically and continuously deployed infotainment systems, it is crucial to focus on verifying software based on actual user scenarios. Traditional user scenarios have primarily relied on estimating user scenarios based on design specifications or evaluator experience.

Recently, with the growing prevalence of connected car services and the accumulation of user information, user big data has become increasingly dependable, enabling the extraction of details about screens frequently used or displayed during operation by actual users, and facilitating the creation of a user-based flow map by estimating user manipulation information through timestamp data during screen transitions. However, such information may not include details about screens that are newly added or changed when the software is updated and redeployed.

Therefore, in this technological field, there is a need for a technology that can estimate user manipulations of newly deployed software and verify the software based on scenarios.

### SUMMARY

It is an object of the present disclosure to provide a software verification method and apparatus capable of deriving a flow of a new screen based on internal logs and state information during a random testing process for system stability assessment of changed software specifications.

It is another object of the present disclosure to provide a software verification method and apparatus capable of, during new software deployment, assigning transition probabilities to the flow map of existing software based on existing and updated information and applying probability tags based on the assessment priorities of the evaluator.

It is still another object of the present disclosure to provide a software verification method and apparatus capable of estimating user manipulations of newly deployed software and verifying the software based on scenarios.

In order to accomplish the above objects, a software verification method according to an embodiment of the present disclosure includes receiving data for software verification from an external server or external device, generating a flow map based on the received data, updating the flow map based on updated change specifications of the software, reconfiguring the updated flow map based on estimated usage frequency of a display identifier (ID) added in the updated change specifications of the software, and verifying the changed specifications of the software by performing random tests on the reconfigured flow map, wherein the display ID is a unique identifier assigned to each screen displayable during a software execution process.

Here, the flow map may be generated based on at least one of the display ID, time information, or exposure probability information of each display ID.

Here, the usage frequency of the added display ID is estimated based on the frequency of display of the display ID immediately before the added display ID and the frequency of screen transition to the display ID immediately after the added display ID, on the basis of the flow map before the software is updated.

Here, the generating of the flow map may include generating user exposure frequency data per display ID, generating a screen operation flow based on a timestamp, and generating the flow map based on the user exposure frequency data and the screen operation flow.

Here, the updating of the flow map may include filtering a display added or removed based on a user experience (UX) change specifications of the software, filtering database (DB) data added or removed based on communication database (DB) change specifications of the software, generating a list of added or modified display IDs according to the updated change specifications of the software, classifying the display IDs within the generated list into added display IDs and modified display IDs, detecting the added display IDs by performing random tests on the software, and updating the flow map based on the connectivity between the added display IDs and existing display IDs.

Here, the reconfiguring of the flow map may include estimating the usage frequency of the added display ID, receiving weights for the display IDs affected by the changed specifications of the updated software from a user, and reconfiguring the updated flow map based on the usage frequency of the added display ID and the weights for the display IDs affected by the changed specifications.

Here, the data for software verification may include information on user screens of the software and user manipulation information.

Here, the tests may be random tests.

Here, the software may be infotainment platform software for a vehicle.

Here, the software may be associated with an infotainment platform of a vehicle.

Meanwhile, a software verification apparatus according to an embodiment of the present disclosure includes a transceiver configured to receive data for software verification from an external server or external device, and a processor configured to generate a flow map based on the received data, update the flow map based on updated change specifications of the software, reconfigure the updated flow map based on estimated usage frequency of a display identifier (ID) added in the updated change specifications of the software, and verify the changed specifications of the software by performing random tests on the reconfigured flow map, wherein the display ID is a unique identifier assigned to each screen displayable during a software execution process.

Here, the flow map may be generated based on at least one of the display ID, time information, or exposure probability information of each display ID.

Here, the usage frequency of the added display ID is estimated based on the frequency of display of the display ID immediately before the added display ID and the frequency of screen transition to the display ID immediately after the added display ID, on the basis of the flow map before the software is updated.

Here, the processor may generates user exposure frequency data per display ID, generate a screen operation flow based on a timestamp, and generate the flow map based on the user exposure frequency data and the screen operation flow.

Here, the processor may filter a display added or removed based on a user experience (UX) change specifications of the software, filter database (DB) data added or removed based communication database (DB) change specifications of the software, generate a list of added or modified display Ids according to the updated change specifications of the software, classify the display IDs within the generated list into added display IDs and modified display IDs, detect the added display IDs by performing random tests on the software, and update the flow map based on the connectivity between the added display IDs and existing display IDs.

Here, the processor may estimate the usage frequency of the added display ID, receive weights for the display IDs affected by the changed specifications of the updated software from a user, and reconfigure the updated flow map based on the usage frequency of the added display ID and the weights for the display IDs affected by the changed specifications.

Here, the data for software verification may include information on user screens of the software and user manipulation information.

Here, the software may be associated with an infotainment platform of a vehicle.

A vehicle may include the software verification apparatus.

As set forth in the various embodiments, the present disclosure is capable of verifying user scenarios plausible in the field by modeling action scenarios based on existing user data using probability criteria and intensively checking the action scenarios by assigning weights, thereby improving evaluation efficiency.

In addition, for features newly introduced through software updates, the present disclosure reflects and verifies a display identifier (ID) newly applied through the flow map based on the existing page transition probability, allowing estimation of the probability for the user to enter the newly added screen based on the probability of the display ID before the addition of the new screen.

Furthermore, when the verification result falls below the expected frequency or probability due to the influence of the usage rate and complexity of the preceding pages leading to the screen, the system designer can verify the design estimate by rearranging the screen to a path with a higher exposure probability in the flow map depending on the degree of exposure need of the screen.

The advantages of the present disclosure are not limited to the aforesaid, and other advantages not described herein may be clearly understood by those skilled in the art from the descriptions below.

### BRIEF DESCRIPTION OF THE DRAWINGS

FIG. 1 is a diagram illustrating a software verification apparatus according to an embodiment of the present disclosure.

FIG. 2 is an exemplary graph representing user exposure frequencies for individual display IDs;

FIG. 3 is a diagram illustrating exemplary user scenarios based on time information and display IDs.

FIG. 4 is a diagram illustrating an exemplary flow map generated by including per-display ID exposure probabilities in respective user scenarios of FIG. 3 and defining main flows based on the probabilities.

FIG. 5 is a diagram illustrating an exemplary flow map of FIG. 4 after being updated with changed software specifications.

FIG. 6 is a diagram illustrating a part of the flow map of FIG. 4 after being reconfigured;

FIG. 7 is a flowchart illustrating a software verification method according to an embodiment of the present disclosure.

FIG. 8 is a flowchart illustrating details of generating the flow map in FIG. 7;

FIG. 9 is a flowchart illustrating details of updating the flow map in FIG. 7;

FIG. 10 is a flowchart illustrating details of reconfiguring the flow map in FIG. 7; and

FIG. 11 is a flowchart illustrating details of verifying changed software specifications in FIG. 7.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, descriptions are made of the embodiments disclosed in the present specification with reference to the accompanying drawings in which the same reference numbers are assigned to refer to the same or like components and redundant description thereof is omitted. In addition, detailed descriptions of well-known technologies related to the embodiments disclosed in the present specification may be omitted to avoid obscuring the subject matter of the embodiments disclosed in the present specification. In addition, the accompanying drawings are only for easy understanding of the embodiments disclosed in the present specification and do not limit the technical spirit disclosed herein, and it should be understood that the embodiments include all changes, equivalents, and substitutes within the spirit and scope of the disclosure.

As used herein, terms including an ordinal number such as “first” and “second” can be used to describe various components without limiting the components. The terms are used only for distinguishing one component from another component.

It will be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening component present.

As used herein, the singular forms are intended to include the plural forms as well, unless the context clearly indicates otherwise.

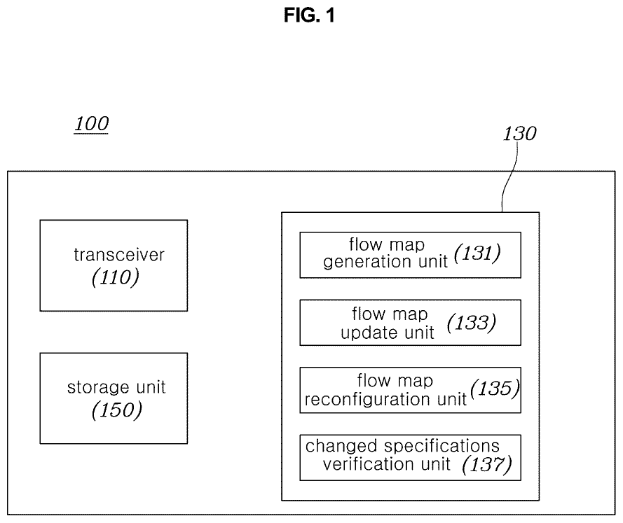

FIG. 1 is a diagram illustrating a software verification apparatus according to an embodiment of the present disclosure.

With reference to FIG. 1, the software verification apparatus 100 according to an embodiment of the present disclosure includes a transceiver 110, a processor 130, and a storage unit 150.

The transceiver 110 may receive data for software verification.

Here, the transceiver 110 may receive big data related to infotainment platform software from an external server or external device.

The processor 130 performs software verification based on the data acquired from the transceiver 110.

The processor 130 include a flow map generation unit 131, a flow map update unit 133, a flow map reconfiguration unit 135, and a change specification verification unit 137.

The flow map generation unit 131 generates a flow map based on display IDs, time information, and per-display ID exposure probability information.

Here, the display ID refers to a unique identifier assigned to each screen that may be displayed during the software execution process.

With the consent of the customer, information about the use of the software is collected through big data, which makes it possible to estimate not only user manipulation information based on information about the most frequently used screens and time information but also user scenarios based on display screen criteria.

Here, the flow map generation unit 131 may categorize per-display ID user exposure frequencies to facilitate the creation of the flow map.

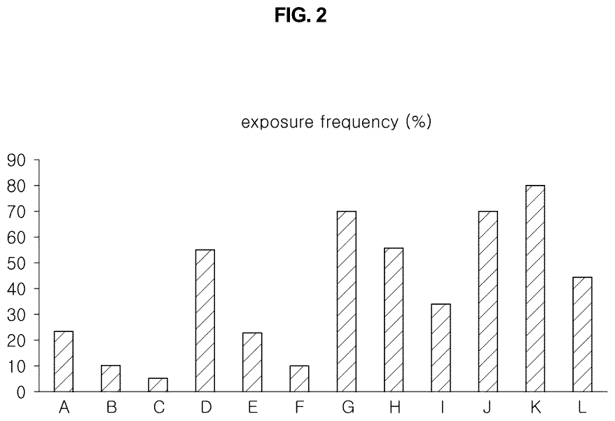

For example, with reference to FIG. 2, the display IDs may be assigned from ‘A’ to ‘L’, and the per-display ID exposure frequencies may be represented as a percentage indicating the probability of being displayed on the screen.

In addition, the flow map generation unit 131 generates user scenarios by reclassifying previous screen information and user manipulation information for display ID exposure based on time information, i.e., timestamps, and display IDs.

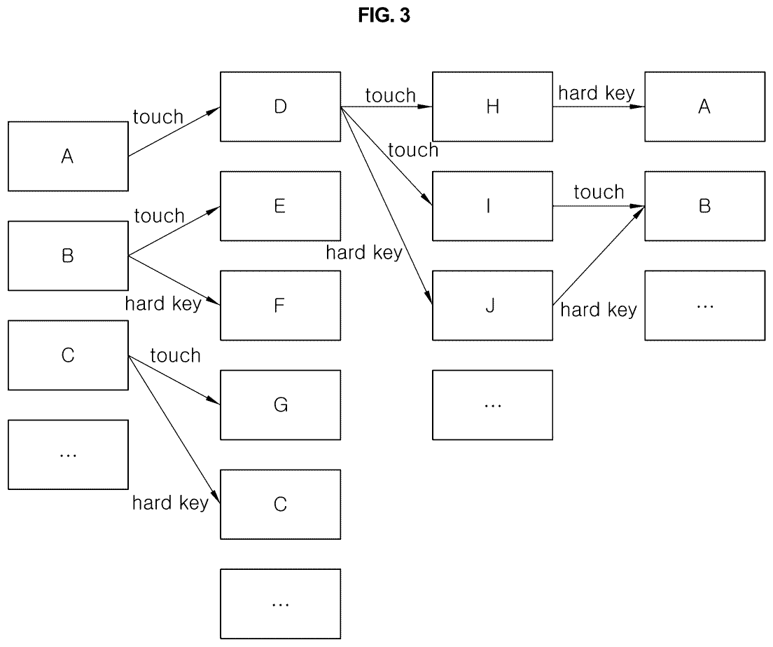

FIG. 3 is a diagram illustrating exemplary user scenarios based on time information and display IDs.

With reference to FIG. 3, it can be observed that the user scenarios may include causal relationship information about the order in which the display IDs are displayed on the user screen.

The flow map generation unit 131 generates a flow map by including the per-display ID exposure probabilities in the user scenarios and defining main flows based on the probabilities.

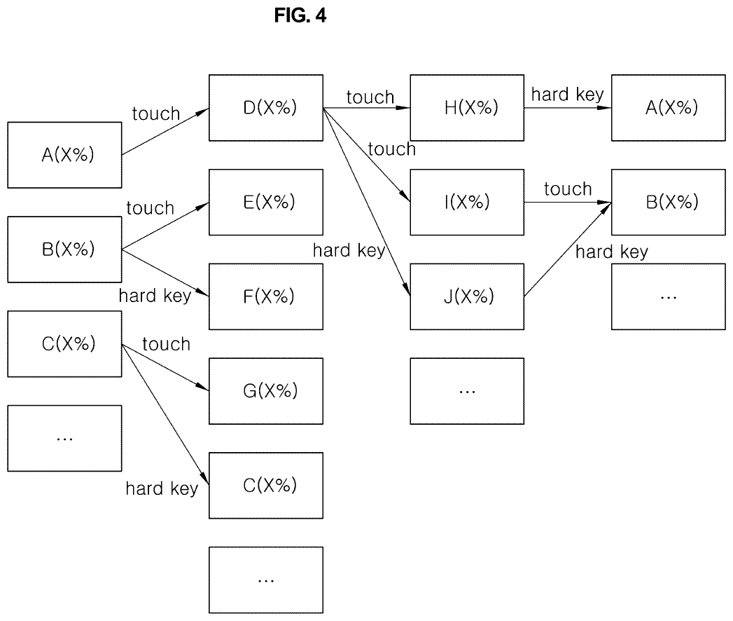

FIG. 4 is a diagram illustrating an exemplary flow map generated by including per-display ID exposure probabilities in respective user scenarios of FIG. 3 and defining main flows based on the probabilities.

With reference to FIG. 4, it can be observed that the flow map includes not only causal relationship information about the order in which the display IDs are displayed on the user screen in user scenarios but also information about the probability of transitioning from one display ID to another.

In this case, the user manipulation information during each screen transition process is structured using a database (DB) format, and the system control for these actions may include necessary information that can be implemented through infotainment system verification protocols or separate simulation input devices.

Here, the necessary information may include database information and coordinate information.

In addition, the user manipulation information may include touch input information, hard key input information, user input information, and signal input information.

With reference to FIG. 1, the flow map update unit 133 checks the changed software specifications and updates the flow map generated by the flow map generation unit 131 based on the information related to these specifications.

Here, the changed software specifications may include user experience (UX) change specifications and communication database (DB) change specifications.

Here, the flow map update unit 133 filters out the display IDs added or removed for UX change specifications and filters out the DB data added or removed for the communication database (DB) change specifications.

In addition, the flow map update unit 133 generates a list of relevant display IDs by distinguishing display IDs that are added and display IDs that are changed according to the specification change based on the filtered information, and classifies the display IDs into added display IDs and changed display IDs.

In addition, the flow map update unit 133 performs random tests for system stability verification based on the modified software, checking the newly added display IDs each time the screen changes using internal data or internal state information data of the target system, logging, and extracting the display IDs in the generated display ID list, for the purpose of identifying the flow enterable with the newly added display IDs.

Here, upon detecting newly added display IDs, the flow map update unit 133 identifies user manipulation information for entering these IDs and reconfigures the connectivity with existing display IDs.

Here, the flow map update unit 133 adds the newly added display IDs from the changed software specifications to the flow map generated by the flow map generation unit 131 and assigns tags to the display IDs affected by specification changes.

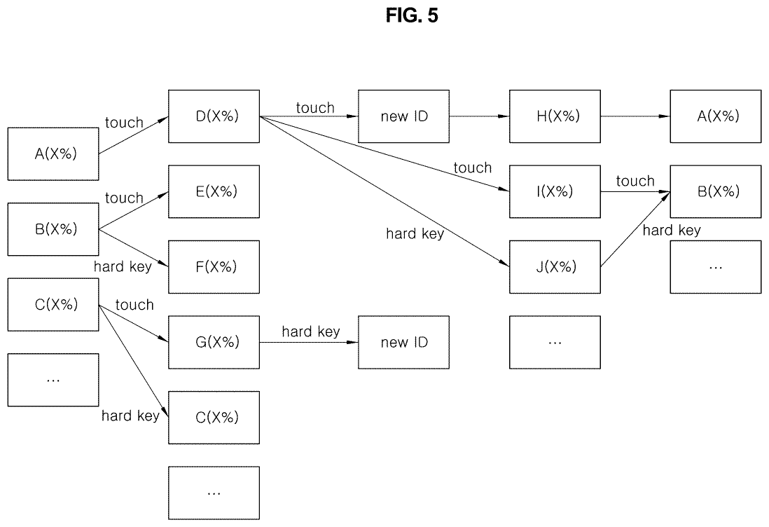

FIG. 5 is a diagram illustrating an exemplary flow map of FIG. 4 after being updated with changed software specifications.

As shown in FIG. 5, new IDs, which are newly added display IDs in the changed software specifications, are added to the flow map of FIG. 4, and tags are assigned to the display IDs F, H, and new IDs affected by the specification change.

With reference to FIG. 1 again, the flow map reconfiguration unit 135 estimates the usage frequency of the newly added display IDs, reconstructs the flow map based on this estimation, and conducts random tests using the reconstructed flow map.

For newly added display IDs, it is difficult to estimate their usage frequency because these Ids are mostly associated with newly introduced features for which existing user data is not available.

Here, the flow map reconfiguration unit 135 may reconfigure the flow map by incorporating the estimated screen transition probabilities into the updated flow map from the flow map update unit 133.

In this case, the reconfigure flow map may be used as a predictive model based on transition probabilities, irrespective of the actual functionality associated with the new IDs.

Here, separate tags are assigned to display IDs affected by the specification changes, and the flow map is configure to allow the evaluator to assign weights arbitrarily.

Meanwhile, when performing the random test based on the reconfigure flow map, the random test may be conducted based on the weights assigned by the evaluator.

In this case, the flow map reconfiguration unit 135 calculates the frequency of display of the display ID immediately before the newly added display ID and the frequency of screen transition to the display ID immediately after the newly added display ID on the basis of the existing flow map and estimates the usage frequency of a newly added display ID based on the calculation result.

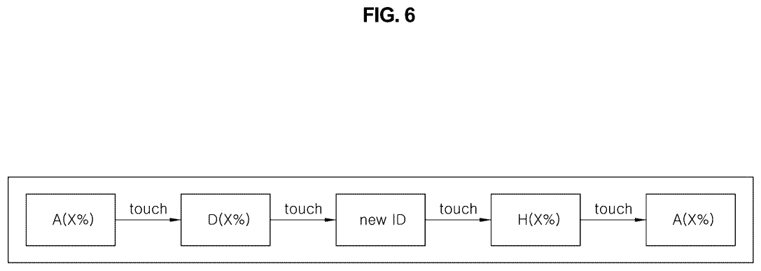

For example, with reference to FIGS. 4 and 6, when the ‘new ID’ is added between the ‘D’ screen and the ‘H’ screen, based on the existing flow map, transitions from the ‘D’ screen to the ‘H’ screen, T screen, and ‘J’ screen are possible with probabilities assumed as a, b, c %, respectively. In this case, the probability of transitioning from the ‘D’ screen to the new ID may be estimated as (a+b+c)/3%.

Here, the display ID ‘H,’ which is affected by the specification change, is tagged separately, and the evaluator may arbitrarily assign a weight of X+a % adjusted from the existing X % weight, reflecting the evaluation focus selectively. The main user action scenarios may be reconstructed based on the predictive model reflected in this way.

The change specification verification unit 137 performs random tests based on the flow map reconfigured by the flow map reconfiguration unit 135 to verify the changed specifications.

Here, the change specification verification unit 137 may generate concentrated verification result comparison data based on the changed specifications and existing user data.

In addition, the change specification verification unit 137 may estimate the user utilization rate of new or modified flows based on the user prediction model.

Here, the change specification verification unit 137, at each decision point, applies a probability algorithm to assign weights to specific coordinate ranges or specific hard key operations for transitioning to the next display screen, incorporating evaluation algorithms to ensure focused verification based on high probabilities during extended testing. This makes it possible to intensively verify whether normal transitions work with flow coverage for screens affected by the changed specifications and whether errors related to system stability such as Crash and Anr occur by monitoring the logs in the process.

Through this focused verification, the system stability for new or changed specifications can be efficiently validated, reducing the probability of errors occurring in real-world scenarios by relying on actual changed specifications and user data, which is a concentrated scenario-based verification approach compared to traditional consistent and equal functional verification methods.

The storage unit 150 stores information received by the transceiver 110 and information generated by the processor 130.

Here, the storage unit 150 may be implemented using a database (DB) or memory.

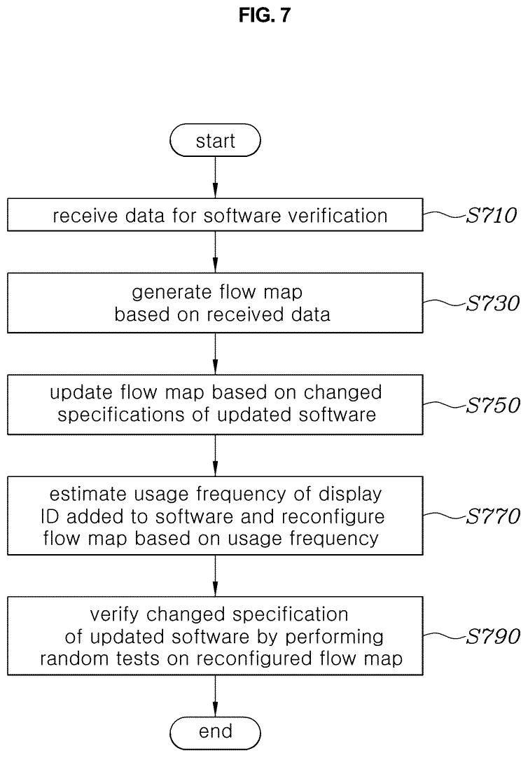

FIG. 7 is a flowchart illustrating a software verification method according to an embodiment of the present disclosure.

The software verification method according to this embodiment may be performed by each component of the software verification apparatus 100 of FIG. 1.

With reference to FIG. 7, the software verification apparatus 100 receives data for software verification at step S710.

Here, the transceiver 110 may receive big data related to infotainment platform software from an external server or external device.

At step S730, the software verification apparatus 100 generates a flow map based on the data received at step S710.

At step S750, the software verification apparatus 100 updates the flow map generated at step S730 based on the changed specifications of the updated software.

At step S770, the software verification apparatus 100 estimates the usage frequency of newly added display IDs in the software and reconfigures the flow map based on this estimation.

At step S790, the software verification apparatus 100 performs random tests on the flow map reconfigured step S770 to verify the changed specifications of the updated software.

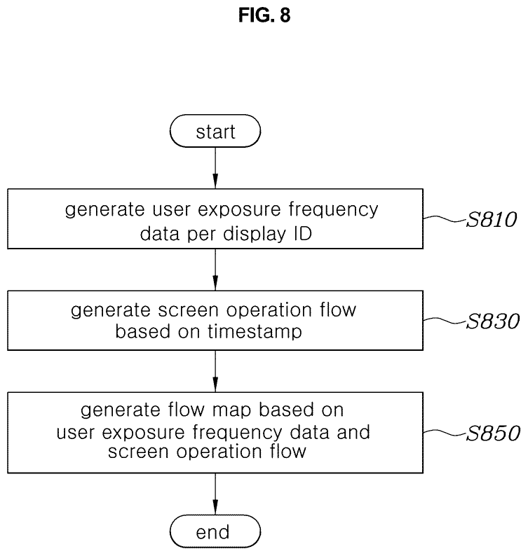

FIG. 8 is a flowchart illustrating details of generating the flow map at step S730 in FIG. 7.

According to the embodiment of FIG. 8, step S730 of generating a flow map may be performed by the flow map generation unit 131 in FIG. 1.

With reference to FIG. 8, the flow map generation unit 131 generates per-display ID user exposure frequency data at step S810.

At step S830, the flow map generation unit 131 generates a screen operation flow based on timestamps.

At step S850, the flow map generation unit 131 generates the flow map based on the user exposure frequency data generated at step S810 and the screen operation flow generated at step S830.

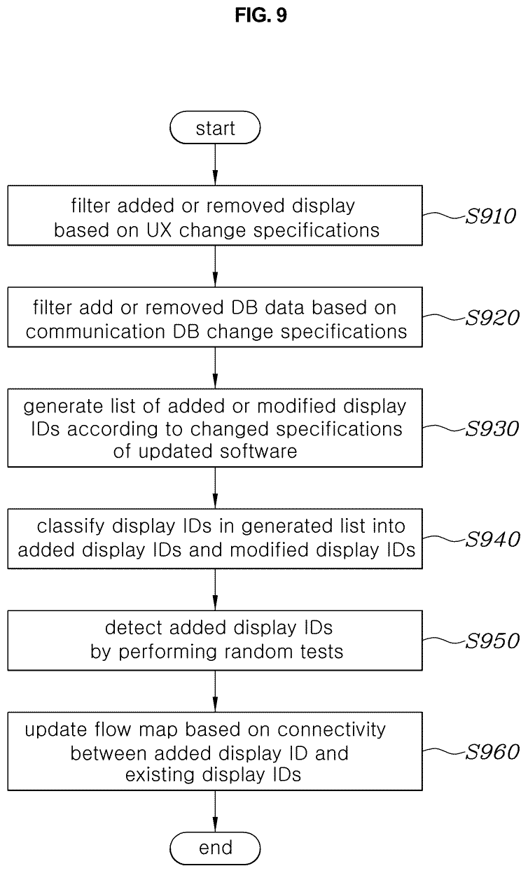

FIG. 9 is a flowchart illustrating details of updating the flow map at step S750 in FIG. 7.

According to the embodiment of FIG. 9, step S750 of updating the flow map may be performed by the flow map update unit 133.

With reference to FIG. 9, the flow map update unit 133 filters, at step S910, displays added or removed based on the user experience (UX) change specifications.

At step S920, the flow map update unit 133 filters database (DB) data added or removed based the communication database (DB) change specifications.

At step S930, the flow map update unit 133 generates a list of added or modified display IDs based on the specification changes of the updated software.

At step S940, the flow map update unit 133 classifies the display IDs within the generated list into added display IDs and modified display IDs.

At step S950, the flow map update unit 133 performs random tests to detect added display IDs.

At step S960, the flow map update unit 133 updates the flow map based on the connectivity between the added display IDs and existing display IDs.

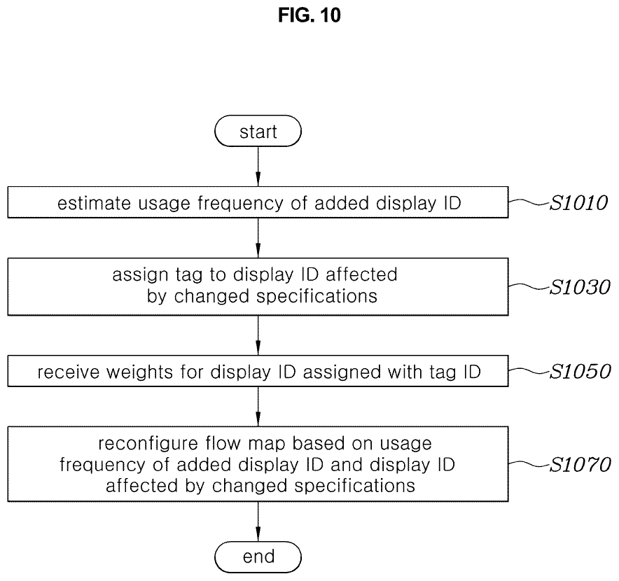

FIG. 10 is a flowchart illustrating details of reconfiguring the flow map at step S770 in FIG. 7.

According to the embodiment of FIG. 10, step S770 of reconfiguring the flow map may be performed by the flow map reconfiguration unit 135 in FIG. 1.

With reference to FIG. 10, the flow map reconfiguration unit 135 estimates the usage frequency of the added display IDs.

In this case, the flow map reconfiguration unit 135 calculates the frequency of display of the display ID immediately before the newly added display ID and the frequency of screen transition to the display ID immediately after the newly added display ID on the basis of the existing flow map and estimates the usage frequency of a newly added display ID based on the calculation result.

The flow map reconfiguration unit 135 assigns, at step S1030, tags to the display IDs affected by the specification change and receives weights for the tag-assigned display IDs from the user at step S1050.

At step S1070, the flow map reconfiguration unit 135 reconfigures the flow map based on the usage frequency of newly added display IDs and the weights assigned to display IDs affected by specification changes.

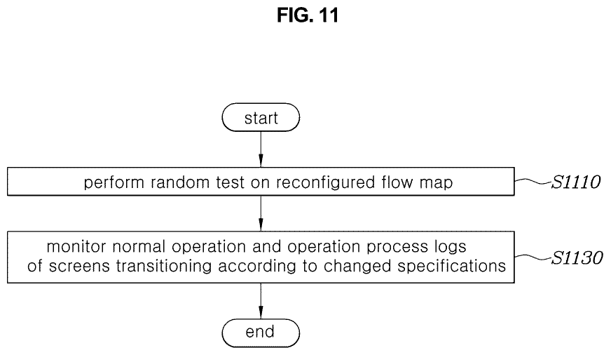

FIG. 11 is a flowchart illustrating details of verifying the changed software specifications at step S790 in FIG. 7.

According to the embodiment of FIG. 11, step S790 of verifying the changed software specifications may be performed by the changed specifications verification unit 137 in FIG. 1.

With reference to FIG. 11, the changed specifications verification unit 137 may perform random tests on the reconfigured flow map at step S1110.

At step S1130, the changed specifications verification unit 137 monitors the normal operation and operation process logs of screens transitioning according to the changed specifications of the software.

Meanwhile, the present disclosure may be applied to verify updates in software associated with a vehicle infotainment system, including newly added features and changes of external signal inputs and user-operated keys, as follows.

First, it is performed to check the data for the platform on the big data server based on the version of the software before the update, extract the data by frequency of display for each display screen ID, structure screen transition flow between individual IDs based on comparison of data including time and operation information, and store the screen transition flow in a separate flow map database. The flow map database includes information about the screen display frequency for each ID, the operation methods for transitioning between screens, and the display ID information for the next screen after the operation. Additionally, a structure file with a separate tag is stored in the flow map display, allowing the evaluator to change the weights based on the probability for each display ID.

Here, a separate tag is assigned to the flow map database by checking the display ID of the newly added feature based on the changed specification and the ID changeable due to the communication DB and user operation.

Here, random tests are conducted to verify the transition flow of the newly added feature. Through the random tests, it is possible to verify system stability, and simultaneously, monitoring internal logs to extract inter-screen transition information and the operation information at corresponding points. In this case, the data update is performed by extracting transition information linkable with the existing flow map from the collected data. The updated flow map database includes flows containing operation (input) information that can be entered from newly added display IDs and existing display IDs.

In this case, since there is no existing user data for the newly added display IDs, multiple branch probabilities based on IDs that can transition to the new ID in the initial flow map are averaged and assigned to the new IDs. The weight tags assigned to the newly added IDs in this way may be manually input based on the evaluator's decision or the average value automatically assigned.

Based on the individual screen transition probabilities in the finally updated flow map, the flow that users are most likely to perform frequently is extracted, and intensive verification for the changed specifications is performed by concentrating on reproducing this derived flow. In this process, it is possible to identify flows that operate in unexpected paths or portions that operate with flows or probabilities significantly different from the existing ones due to the influence of software changes, enabling the confirmation and validation of errors. In this process, when the probability of a flow is lower than the probability estimated by the flow prediction model implemented based on existing user data, it is possible to suggest user operation scenarios to increase user usage frequency.

As described in the various embodiments, the present disclosure is capable of verifying user scenarios plausible in the field by modeling action scenarios based on existing user data using probability criteria and intensively checking the action scenarios by assigning weights, thereby improving evaluation efficiency.

In addition, for features newly introduced through software updates, the present disclosure reflects and verifies a display identifier (ID) newly applied through the flow map based on the existing page transition probability, allowing estimation of the probability for the user to enter the newly added screen based on the probability of the display ID before the addition of the new screen.

Furthermore, when the verification result falls below the expected frequency or probability due to the influence of the usage rate and complexity of the preceding pages leading to the screen, the system designer can verify the design estimate by rearranging the screen to a path with a higher exposure probability in the flow map depending on the degree of exposure need of the screen.

Meanwhile, the present disclosure described above may be implemented as computer-readable codes on a medium on which a program is recorded. Computer-readable media include all types of recording devices in which data readable by a computer system are stored. Examples of the computer-readable media include Hard Disk Drive (HDD), Solid State Disk (SSD), Silicon Disk Drive (SDD), ROM, RAM, CD-ROM, magnetic tape, floppy disk, optical data storage device, etc. Accordingly, the above detailed description should not be construed as restrictive in all respects but as exemplary. The scope of the present disclosure should be determined by a reasonable interpretation of the appended claims and includes all modifications within the equivalent scope of the present disclosure.

What is claimed is:

1. A software verification method comprising:
receiving, by a transceiver, data for software verification from an external server or an external device;
generating, by a processor, a flow map based on the received data;
updating, by the processor, the flow map based on updated change specifications of software;
reconfiguring, by the processor, the updated flow map based on estimated usage frequency of a display identifier (ID) added in the updated change specifications of the software; and
verifying, by the processor, the changed specifications of the software by performing tests on the reconfigured flow map,
wherein the display ID is a unique identifier assigned to each screen displayable during a software execution process.

2. The software verification method of claim 1, wherein the flow map is generated based on at least one of the display ID, time information, or exposure probability information of each display ID.

3. The software verification method of claim 1, wherein the usage frequency of the added display ID is estimated based on the frequency of display of the display ID immediately before the added display ID and a frequency of screen transition to the display ID immediately after the added display ID, on the basis of the flow map before the software is updated.

4. The software verification method of claim 1, wherein generating the flow map comprising:
generating user exposure frequency data per display ID;
generating a screen operation flow based on a timestamp; and
generating the flow map based on the user exposure frequency data and the screen operation flow.

5. The software verification method of claim 1, wherein updating the flow map comprises:
filtering a display added or removed based on a user experience (UX) change specifications of the software;
filtering database (DB) data added or removed based on communication database (DB) change specifications of the software;
generating a list of added or modified display IDs according to the updated change specifications of the software;
classifying the display IDs within the generated list into added display IDs and modified display IDs;
detecting the added display IDs by performing random tests on the software; and
updating the flow map based on connectivity between the added display IDs and existing display IDs.

6. The software verification method of claim 1, wherein reconfiguring the flow map comprises:
estimating the usage frequency of the added display ID;
receiving weights for the display IDs affected by the changed specifications of the updated software from a user; and
reconfiguring the updated flow map based on the usage frequency of the added display ID and the weights for the display IDs affected by the changed specifications.

7. The software verification method of claim 1, wherein the data for software verification comprises information on user screens of the software and user manipulation information.

8. The software verification method of claim 1, wherein the tests are random tests.

9. The software verification method of claim 1, wherein the software is infotainment platform software for a vehicle.

10. The software verification method of claim 1, wherein the software is associated with an infotainment platform of a vehicle.

11. A software verification apparatus comprising:
a transceiver configured to receive data for software verification from an external server or an external device; and
a processor configured to generate a flow map based on the received data, update the flow map based on updated change specifications of software, reconfigure the updated flow map based on estimated usage frequency of a display identifier (ID) added in the updated change specifications of the software, and verify the changed specifications of the software by performing tests on the reconfigured flow map,
wherein the display ID is a unique identifier assigned to each screen displayable during a software execution process.

12. The software verification apparatus of claim 11, wherein the flow map is generated based on at least one of the display ID, time information, or exposure probability information of each display ID.

13. The software verification apparatus of claim 11, wherein the usage frequency of the added display ID is estimated based on the frequency of display of the display ID immediately before the added display ID and the frequency of screen transition to the display ID immediately after the added display ID, on the basis of the flow map before the software is updated.

14. The software verification apparatus of claim 11, wherein the processor generates user exposure frequency data per display ID, generates a screen operation flow based on a timestamp, and generates the flow map based on the user exposure frequency data and the screen operation flow.

15. The software verification apparatus of claim 11, wherein the processor filters a display added or removed based on a user experience (UX) change specifications of the software, filters database (DB) data added or removed based communication database (DB) change specifications of the software, generates a list of added or modified display Ids according to the updated change specifications of the software, classifies the display IDs within the generated list into added display IDs and modified display IDs, detects the added display ID by performing random tests on the software, and updates the flow map based on the connectivity between the added display ID and existing display IDs.

16. The software verification apparatus of claim 11, wherein the processor estimates the usage frequency of the added display ID, receives weights for the display IDs affected by the changed specifications of the updated software from a user, and reconfigures the updated flow map based on the usage frequency of the added display ID and the weights for the display IDs affected by the changed specifications.

17. The software verification apparatus of claim 11, wherein the data for software verification comprises information on user screens of the software and user manipulation information.

18. The software verification apparatus of claim 11, wherein the tests are random tests.

19. The software verification apparatus of claim 11, wherein the software is associated with an infotainment platform of a vehicle.

20. A vehicle comprising the software verification apparatus of claim 11.
